(19) United States
(12) Patent Application Publication
(10) Pub. No.: US 2006/0050392 A1
(43) Pub. Date: Mar. 9, 2006

(54) Diffraction grating

(76) Inventor: Joachim Schulz, Stuttgart (DE)

Correspondence Address: FISH & RICHARDSON PC, P.O. BOX 1022, MINNEAPOLIS, MN, 55440-1022, US

(21) Appl. No.: 11/220,370

(22) Filed: Sep. 6, 2005

(30) Foreign Application Priority Data
Sep. 3, 2004 (DE) 10 2004 042 748.8

(51) Int. Cl. G02B 5/18

(52) U.S. Cl. 359/573; 359/558

(57) ABSTRACT

A diffraction grating for generating radially polarized laser radiation within a laser resonator is designed as a periodic or quasi-periodic, concentric or spiral grating with a grating period larger than the laser wavelength. The grating period and shape are selected in such a manner that the TM reflectance of the diffraction grating in a diffraction order corresponding to the laser wavelength is larger than the TE reflectivity of the diffraction grating in that diffraction order.

This application claims priority under 35 U.S.C. § 119 from German application 10 2004 042 748.8, filed Sep. 03, 2004, the entire contents of which are hereby incorporated by reference.

### TECHNICAL FIELD

The present invention relates to a diffraction grating for generating radially polarized laser radiation within a laser resonator, to a corresponding laser resonator comprising such a diffraction grating, and to related methods.

### BACKGROUND

A diffraction grating of this type is disclosed in the article “Optical Elements Of A Laser Cavity For The Production Of A Beam With Axially Symmetric Polarization” by Goncharskii et al., Optics and Spectroscopy Vol. 89, No. 1, 2000, pages 146-149.

This article discloses a diffraction grating for generating radially polarized laser radiation. The diffraction grating comprises a star-shaped grating structure. The grating lines start at a common center and extend in a radial outer direction, and the separation between two neighboring grating lines increases with increasing separation from the center with the result that radially polarized radiation can be obtained only with a large portion of linearly polarized radiation.

U.S. Pat. No. 6,680,799 B1 discloses a sub-wavelength grating for generating radially polarized radiation, having a grating period that is smaller than the wavelength of the incident laser radiation. The sub-wavelength grating is disposed on a dielectric multi-layer mirror and obtains its polarization selectivity through coupling of the undesired polarization into a waveguide mode of the multi-layers or in plasmons in the metallic substrate. The coupling bandwidth is very narrow in principle due to physical conditions, such that adjustment or production of the sub-wavelength gratings is very critical and costly requiring very narrow tolerances.

An object of the present invention is to further develop a diffraction grating of the above-mentioned type in such a manner that it is easy to produce and shows as low a sensitivity to production tolerances as possible.

### SUMMARY

Various aspects of the invention feature a diffraction grating that is a periodic or quasi-periodic, concentric or spiral grating with a grating period larger than the laser wavelength. Preferably, the grating period and the grating shape are selected in such a manner that, relative to the laser wavelength, the TM reflectivity of the diffraction grating in an employed diffraction order is higher than the TE reflectivity of the diffraction grating in this diffraction order.

The diffraction grating is designed for a certain laser wavelength and has a grating period larger than the laser wavelength, with the result that in addition to the zero (m=0) diffraction order, also higher diffraction orders (m=±1,±2, . . . ) are present. Part of the incident laser radiation is not reflected in the employed zero (m=0) or first (m=±1) diffraction order through suitable selection of the grating structure, but is directed (depending on the polarization) more or less also in other diffraction orders. This permits diffraction of a considerable portion of the TE polarization out of the optical axis (for example, of a laser resonator), while the TM polarization is reflected back only in one employed diffraction order (in other words, within the resonator). This results in a higher TE polarization loss in the resonator, which therefore cannot start to oscillate. The exact grating shape is determined via commercially available calculation methods on the basis of the RCWA method (Rigorous Coupled Wave Approach). Experience from high-performance CO₂ lasers has shown that a difference of reflectance within the resonator between TM and TE polarization of 1-2% is sufficient to render TM polarization more preferential than TE polarization.

The grating period of the quasi-periodic diffraction grating preferably varies by less than approximately ±20%, more preferably less than approximately ±10%. Since the exact diffraction direction of the higher diffraction orders (which is determined by the exact grating period) and also the exact portion that is diffracted into the higher diffraction orders is not critical for suppression of the undesired polarization, the production tolerances of the diffraction grating may be large. The diffraction grating should not be exactly matched to coupling into waveguide modes or plasmons, which considerably increases the spectral bandwidth of the system. Moreover, in addition to concentric gratings, spiral gratings can also be realized, the production of which can be simpler (e.g., through diamond turning) than that of concentric gratings. The grating lines of concentric gratings are circular or elliptical and have a common center. The deviation from the exact grating shape preferably varies by less than 20%, more preferably less than 10%.

In preferred metallic or metallically vapour-deposited gratings, the grating period of the diffraction grating is at least approximately 5 times, preferably at least approximately 10 times, larger than its protrusion width. In preferred dielectric gratings, the grating period of the diffraction grating is at least approximately 2 times, preferably at least approximately 4 times, larger than the protrusion width.

Both binary diffraction gratings with protrusions having a rectangular cross-section, and also gratings with protrusions having a trapezoidal or triangular cross-section, can be realized. The protrusions may also be formed with rounded side surfaces due to production. The protrusion width or groove width averaged over the height of the protrusion or depths of the grooves is decisive for the basic function of the grating.

In a first preferred embodiment, the diffraction grating is formed in the surface of a metallic substrate through turning. The production of gratings of this type is facilitated through diamond turning, such as in copper (Cu). The production of such a diffraction grating is thereby hardly more demanding than the production of a normal rear mirror. In particular, the grating grooves and, if desired, the global (mostly concave) curvature can be simultaneously produced, i.e. with the same tool or a second tool in the same fixed support. A further advantage of the metallic substrate, in addition to easy processing with diamond tools, is its high reflectance without requiring further complex coating. A thin vapour-deposited gold layer is possibly advantageous to prevent oxidation of the copper substrate.

In a further preferred embodiment, the diffraction grating is formed in the surface of a dielectric substrate through etching. Gratings of this type can be easily produced, such as in silicon (Si). The required high reflectance is subsequently obtained through metallic or dielectric coating of the substrate and the grating structure.

In a further preferred embodiment, the diffraction grating consists of metallic or dielectric rings or spirals disposed on a surface of a metallic or metallically coated substrate. Structures of this type can be produced with conventional microstructuring techniques, such as microlithography and lift-off or reactive ion etching. This configuration of substrate and grating structure may additionally also be provided with a highly reflective, metallic or dielectric coating to reduce absorption of the diffraction grating, thereby increasing the reflectance.

In a further preferred embodiment, the diffraction grating consists of metallic or dielectric rings or spirals disposed onto a partially reflective, anti-reflective or highly reflective multi-layer mirror which may be disposed onto a dielectric or metallic substrate.

The diffraction grating may be a reflective grating without a transmissive portion, or a partially reflecting grating with a transmissive portion.

The diffraction grating is preferably flat or concavely curved, such as disposed on a curved resonator mirror. The fact that the grating structures are not as small as in sub-wavelength gratings can advantageously reduce technical problems in connection with structure transfer methods also for curved surfaces.

Another aspect of the invention features a laser resonator with a diffraction grating of the above-mentioned design as a fully-reflecting rear mirror, as a partially reflecting decoupling mirror, or as a transmissive element within the laser resonator.

Another aspect of the invention features a method of diffracting light within a laser generator. The method involves reflecting light within a cavity of a laser resonator, and passing at least a part of the light through a diffraction grating. The diffraction grating is a grating selected from the group consisting of periodic, quasi-periodic, concentric and spiral gratings and has a grating period larger than the wavelength of the laser radiation, and the light is refracted in a manner such that the TM reflectance of the diffraction grating in a diffraction order corresponding to the laser wavelength is larger than the TE reflectivity of the diffraction grating in said diffraction order.

In some cases the method includes first forming the diffraction grating in a surface of a metallic substrate in a turning operation.

In some other cases the method includes first forming the diffraction grating in a surface of a metallic substrate by etching the surface and subsequently coating the etched surface.

Various combinations of the features disclosed herein are considered inventive, as indicated, for example, by the combinations of features claimed in the German priority application incorporated herein by reference.

Further advantages of the invention can be extracted from the description and the drawing. The features mentioned above and below may be used individually or collectively in arbitrary combination. The embodiments shown and described are not to be understood as exhaustive enumeration but have exemplary character for describing the invention.

### DESCRIPTION OF DRAWINGS

FIG. 1 shows the basic diffraction behavior of a diffraction grating.

FIG. 2 schematically shows an oblique view (FIG. 2a) and a cross-sectional view (FIG. 2b) of the inventive diffraction grating for generating radially polarized laser radiation.

FIG. 3 shows a detailed view of the diffraction grating in accordance with III in FIG. 2a.

FIG. 4 shows a diffraction grating with a binary grating structure.

FIG. 5 shows the calculated TE and TM reflectances for the diffraction grating of FIG. 4 as a function of the protrusion height (FIG. 5a) and the protrusion width (FIG. 5b).

FIGS. 6a-6d show further embodiments of diffraction gratings in a view analogous to FIG. 4.

FIG. 7 shows a laser resonator comprising the diffraction grating as a rear mirror (FIG. 7a), as a decoupling mirror (FIG. 7b) and as a transmissive element within the laser resonator (FIG. 7c).

FIG. 8 shows calculated TE and TM reflectances for a binary gold grating with rectangular protrusion edges.

FIG. 9 shows calculated TE and TM reflectances for a gold grating with inclined protrusion edges.

FIG. 10 shows a three-dimensional view (FIG. 10a) and a two-dimensional view (FIG. 10b) of calculated TE and TM reflectances for a binary GaAs grating on a partially transmissive, dielectric, multi-layer mirror.

Like reference symbols in the various drawings indicate like elements.

### DETAILED DESCRIPTION

FIG. 1 shows the basic diffraction behavior of a diffraction grating 1 with parallel grating grooves 2 and a grating period Λ that is larger than the wavelength λ of the incident laser radiation 3, i.e. Λ>λ. In this case, the generally valid diffraction equation
Λ*(sin Θ−sin α)=m*λ, with:
α: angle of incidence of the incident laser radiation 3 (α=0 in the embodiment shown);
Θ: angle of reflection or diffraction angle of the deflected laser radiation 4a, 4b; and
m: diffraction order (m=0,±1,±2, . . . );
   shows that with a selected grating period Λ, only a limited number of diffraction orders ‘m’ are present that can propagate in free space. In other words, in addition to the zero (m=0) diffraction order (in case of perpendicular incidence of the laser beam 4a emerging in the opposite direction to the incident laser beam 3), at least the first diffraction orders (m=±1) are present in a different spatial direction (Θ<±90°), as indicated by the emerging laser beams 4b. The diffracted laser beams 4a, 4b with a polarization parallel to the grating grooves 2 are designated as TE-polarized and those with polarization at a right angle to the grating grooves 2 are designated as TM polarized.

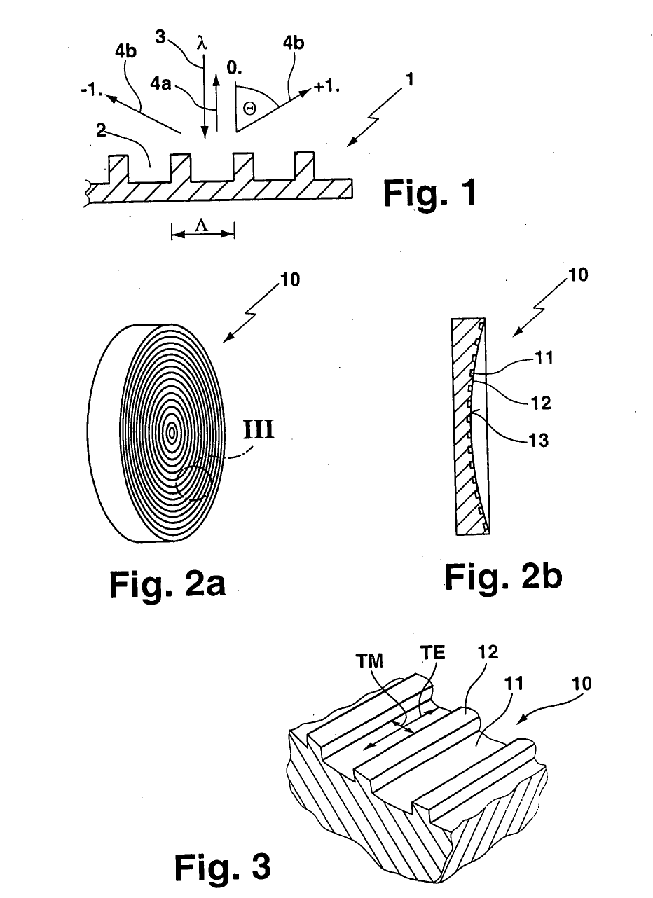

The diffraction grating 10 shown in FIGS. 2a and 2b comprises an annular structure with concentric grating grooves 11 and grating protrusions 12 with a grating period Λ that is larger than the used laser wavelength λ, and a concavely curved grating surface 13. In correspondence with FIG. 3, the diffracted laser beams of this diffraction grating 10 with a polarization extending tangentially to the grating grooves 11 are designated as TE polarized or azimuthally polarized, and those with polarization extending perpendicularly to the grating grooves 11 are designated as TM polarized or radially polarized. The grating period Λ (λ<Λ<10λ) and the grating shape of the diffraction grating 10 are selected in such a manner that the TM reflectance of the diffraction grating 10 relative to the laser wavelength λ in one employed diffraction order (the zero (m=0) in the illustration) is larger than the TE reflectance of the diffraction grating in this employed diffraction order. Compared to the incident TM polarized laser radiation, a larger portion of the incident TE polarized laser radiation is diffracted also in other unused diffraction orders and thereby deflected out of the optical axis of the employed diffraction order. If this diffraction grating 10 is employed, e.g., as a rear mirror in a laser resonator, the TM polarization is reflected only in one desired diffraction order (i.e., within the resonator), while the TE polarization experiences a higher loss in the resonator and therefore cannot start to oscillate. As a result, only radially polarized laser radiation is generated in the resonator.

The parameters (grating period, grating shape) required for generating radially polarized laser radiation are determined through commercially available calculation methods on the basis of the RCWA method (Rigorous Coupled Wave Approach).

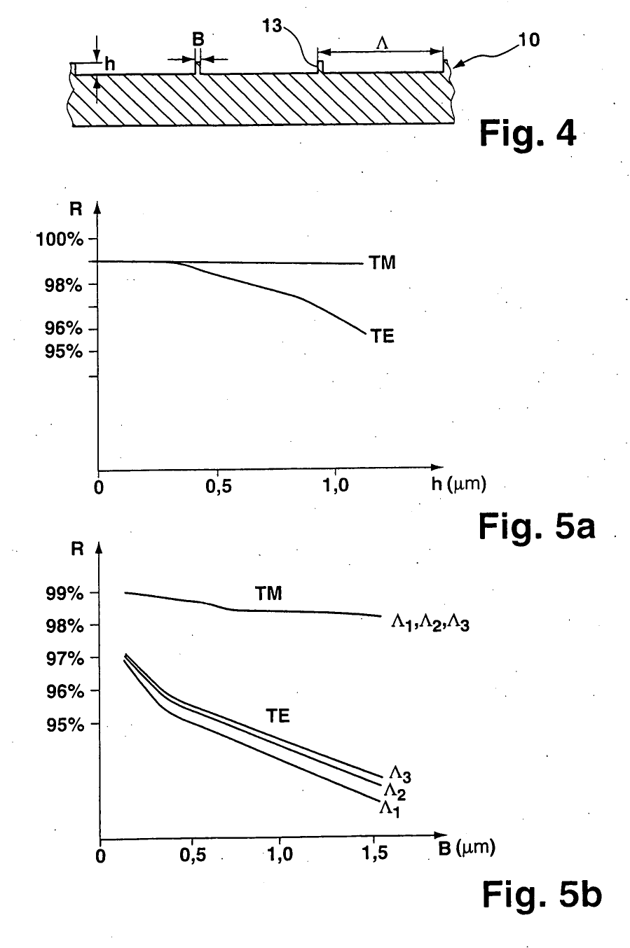

Such RCWA calculations were performed for a gold-plated concentric diffraction grating 10 of copper with the binary grating structure (grating period Λ, grating protrusions 13 with rectangular cross-section, protrusion width B and protrusion height h) shown in FIG. 4 and a perpendicularly incident laser beam (λ=10.6 μm).

FIG. 5a shows the calculated change of the TE and TM reflectance with the protrusion height ‘h’ and a protrusion width B=0.5 μm and a grating period Λ=20 μm. Starting from an unstructured mirror (h=0 μm), the TE reflectance decreases more with increasing protrusion height ‘h’ than the TM reflectance. With h=1.2 μm, a TM reflectance of 98.7% and a TE reflectance of 95.0% in the zero (m=0) diffraction order were calculated. FIG. 5b shows the calculated change of the TE and TM reflectances with a link width B and a link height of h=1.2 μm and three different grating periods (Λ₁=19 μm, Λ₂=20 μm and Λ₃=21 μm). The TE reflectance drops more steeply for all three grating periods with increasing protrusion width B than the TM reflectance, while the TM reflectance extends at a very high level. For Λ₂=20 μm and B=0.5 μm, a TM reflectance of 98.7% and a TE reflectance of 95.3% were calculated and for Λ₃=21 μm and B=0.5 μm, a TM reflectance of 98.7% and a TE reflectance of 95.5% were calculated and for Λ₁=19 μm and B=0.5 μm, a TM reflectance of 98.7% and a TE reflectance of 95.0% were calculated. The small dependence of the TM and TE reflectivities on the grating period Λ shows that deviations in the grating period are not critical, therefore permitting also a quasi-periodic grating.

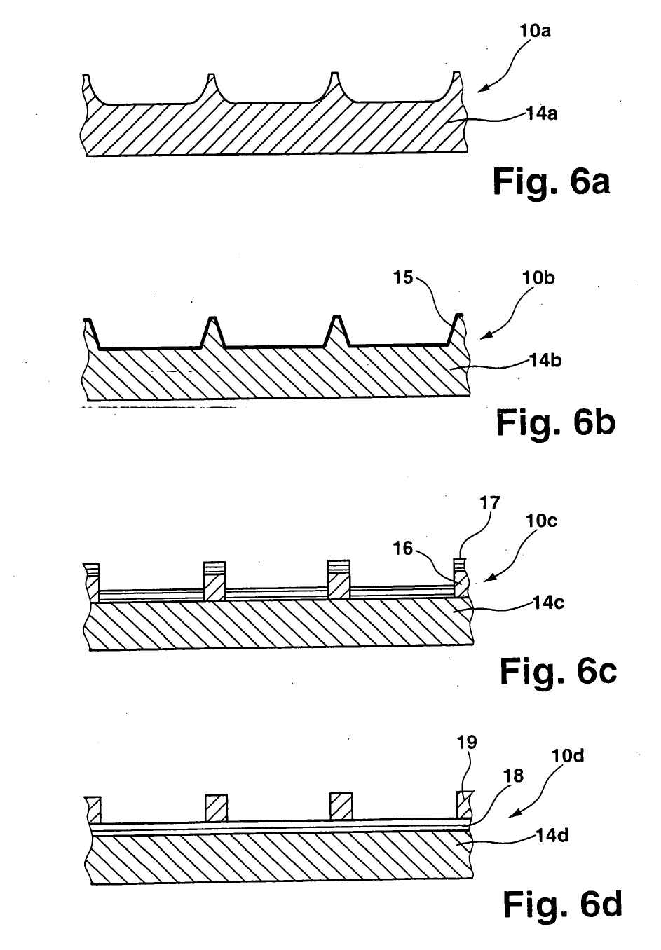

FIG. 6 shows further embodiments of concentric or quasi-concentric diffraction gratings. The diffraction grating 10a shown in FIG. 6a consists of a metallic substrate 14a, such as copper, into which the grating structure is introduced in the form of rotationally symmetric structures through diamond turning with rounded side surfaces. In the diffraction grating 10b shown in FIG. 6b, a V-shaped grating structure was produced through etching of a dielectric substrate 14b and subsequent metallizing (layer 15). The diffraction grating 10c shown in FIG. 6c has a metallic substrate 14c with a dielectric grating 16 produced through etching, which is subsequently provided with a highly reflective metallic or dielectric coating 17. The partially transmissive diffraction grating 10d shown in FIG. 6d is based on a transmissive substrate 14d with a multilayer mirror 18 onto which a metallic or dielectric grating 19 was disposed.

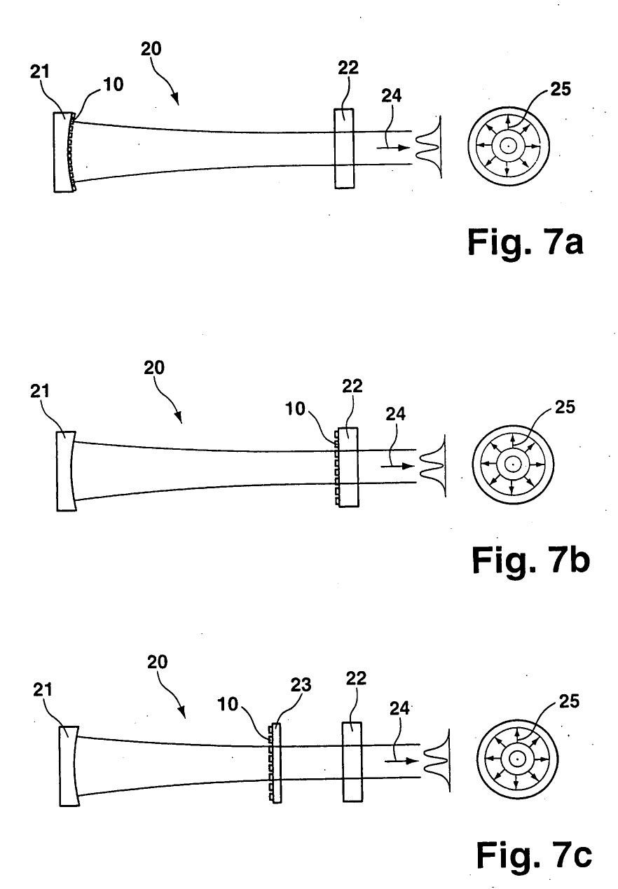

FIG. 7 shows a laser resonator 20 with a rear mirror 21 and a decoupling mirror 22. The rear mirror 21 of FIG. 7a and the decoupling mirror 22 of FIG. 7b are designed as grating mirrors with a concentric or spiral diffraction grating 10, whereas in FIG. 7c a transmissive element 23 with concentric or spiral diffraction grating 10 is disposed within the laser resonator. One can conclude from experience with high-performance CO₂ lasers that a TM and TE reflectance difference of 1-2% within the resonator is sufficient to select the radial or TM polarization in the laser resonator 20. The laser beam 24 leaving the laser resonator 20 is radially polarized as indicated by the radial arrows 25 in the beam cross-section shown in FIG. 7.

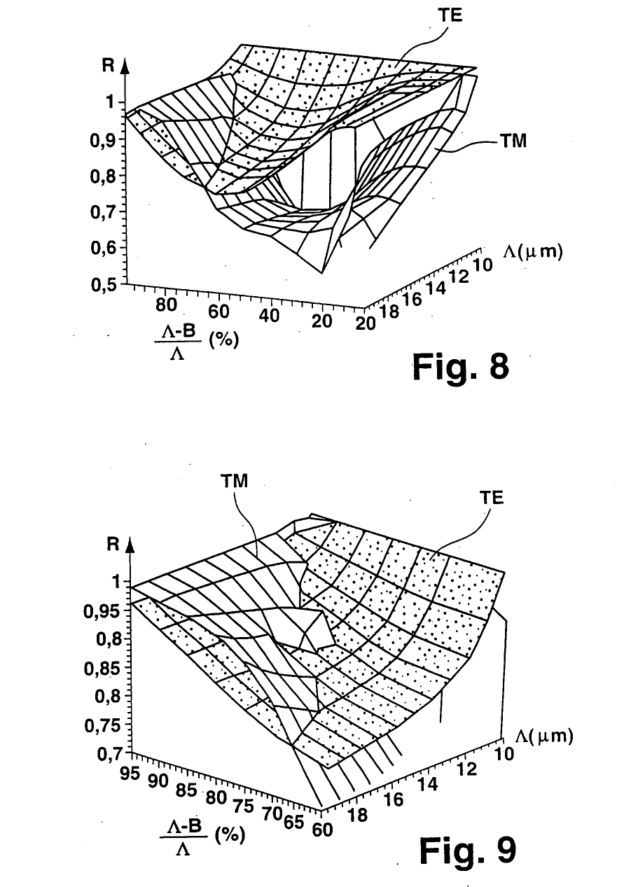

The dependence of the diffraction efficiency, i.e. the reflectance R in the zero (m=0) diffraction order, on the groove width Λ−B (difference between grating period and protrusion width) and on the grating period Λ is shown in FIG. 8 for a binary gold grating (protrusion height h=1 μm and perpendicular protrusion edges) for light incident at a right angle. It shows that the TM reflectance for protrusion widths which are smaller than the groove width is larger than the TE reflectance, whereas both reflectances are relatively low for identical dimensions between protrusion width and groove width, and TE polarization is preferred to TM polarization for large protrusion width and small groove widths, respectively.

The dependence of the reflectance R in the zero (m=0) diffraction order on the average groove width <Λ−B> and on the grating period Λ is shown in FIG. 9 for a gold grating (protrusion height h=1 μm and inclined protrusion edges) for light incident at a right angle. The average groove width <Λ−B> is averaged over the protrusion height. The slope of each protrusion edge is 2.5%*Λ/h and therefore varies with the grating period. Based on the grating normal, the slope of the inclined protrusion edges is, for example, 26° for a 20 μm-grating period and 16° for a 11 μm-grating period. It is shown that, in particular, for groove widths of more than 90° of the grating period and for grating periods of between approximately 12 μm and 20 μm, the TM reflectance is larger than the TE reflectivity.

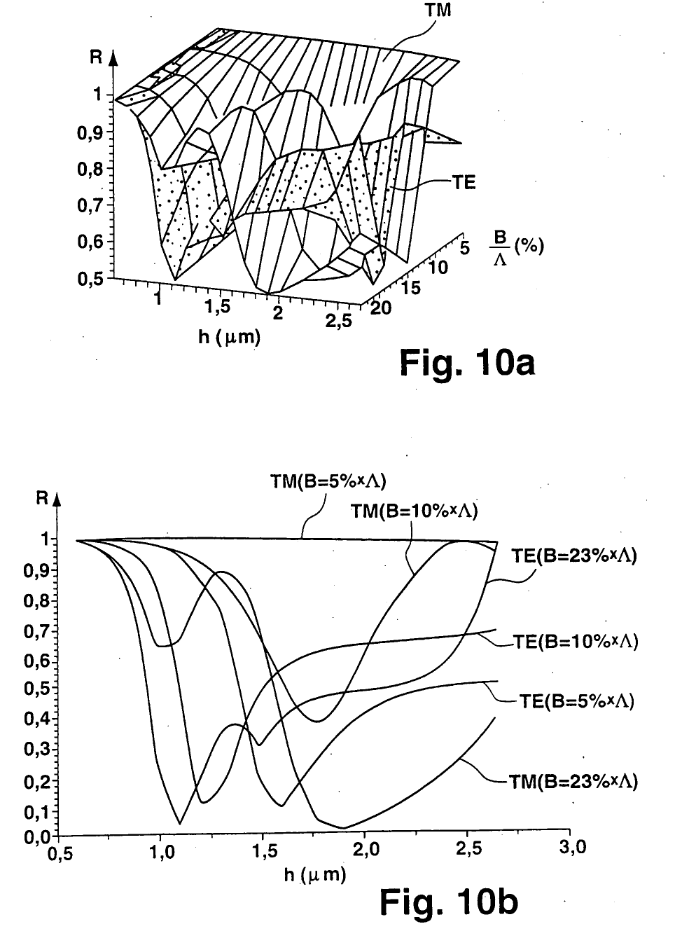

The dependence of the TM and TE reflectances in a dielectric grating (binary GaAs grating with 21 μm grating period on a partially transmissive, dielectric multi-layer mirror 99%) on the protrusion height ‘h’ and protrusion width ‘B’ is shown in FIG. 10a. It shows that the variation between the reflectivities and ratios is larger, and that for R_{TM}>R_{TE} the link widths ‘B’ may be larger than for metallic or metallically coated gratings. FIG. 10b shows a two-dimensional detailed view of FIG. 10a for a 21 μm grating period with different link widths. It shows that, in particular, for link widths ‘B’ of 5%*Λ and 10%*Λ and for small link heights 0.5 μm<h<1.25 μm, the TM reflectance is larger than the TE reflectance.

A number of embodiments of the invention have been described. Nevertheless, it will be understood that various modifications may be made without departing from the spirit and scope of the invention. Accordingly, other embodiments are within the scope of the following claims.

What is claimed is:

1. A diffraction grating arranged to generate radially polarized laser radiation within a laser resonator,
wherein the diffraction grating is a grating which is either periodic or quasi-periodic and either concentric or spiral and which has a grating period larger than the wavelength of the laser radiation; and
wherein the grating is of a period and shape selected in such a manner that the TM reflectance of the diffraction grating in a diffraction order corresponding to the laser wavelength is larger than the TE reflectivity of the diffraction grating in said diffraction order.

2. The diffraction grating of claim 1, wherein the grating period varies by less than about ±20 percent across the grating.

3. The diffraction grating of claim 2, wherein the grating period varies by less than about ±10 percent across the grating.

4. The diffraction grating of claim 1, wherein the grating is metallic or metallically coated and has a grating period at least about 5 times larger than its protrusion width.

5. The diffraction grating of claim 1, wherein the grating is dielectric or dielectrically coated and has a grating period at least about 2 times larger than its protrusion width.

6. The diffraction grating of claim 1, wherein links of the diffraction grating have a rectangular, triangular or trapezoidal cross-section.

7. The diffraction grating of claim 1, wherein links of the diffraction grating have rounded side surfaces.

8. The diffraction grating of claim 1, wherein the diffraction grating is disposed on a surface of a metallic or metallically coated substrate.

9. The diffraction grating of claim 1, wherein the diffraction grating is disposed on a partially reflective, anti-reflective or highly reflective multi-layer mirror.

10. The diffraction grating of claim 1, wherein the diffraction grating is coated with a highly reflective, metallic or dielectric coating.

11. The diffraction grating of claim 1, wherein the diffraction grating is a reflective grating void of any transmissive portion.

12. The diffraction grating of claim 1, wherein the diffraction grating is a partially reflective grating with a transmissive portion.

13. The diffraction grating of claim 1, wherein the diffraction grating is concave.

14. A laser resonator comprising
a housing defining an interior cavity; and
a diffraction grating arranged as one of the group consisting of a fully or partially reflective rear mirror of the resonator, a partially reflective decoupling mirror of the resonator, and a transmissive element within the resonator;
wherein the diffraction grating is a grating which is either periodic or quasi-periodic and either concentric or spiral and which has a grating period larger than the wavelength of the laser radiation; and
wherein the grating is of a period and shape selected in such a manner that the TM reflectance of the diffraction grating in a diffraction order corresponding to the laser wavelength is larger than the TE reflectivity of the diffraction grating in said diffraction order.

15. The laser resonator of claim 14, wherein the grating period varies by less than about ±20 percent across the grating.

16. The laser resonator of claim 14, wherein the grating is metallic or metallically coated and has a grating period at least about 5 times larger than its protrusion width.

17. The laser resonator of claim 14, wherein the grating is dielectric or dielectrically coated and has a grating period at least about 2 times larger than its protrusion width.

18. A method of diffracting light within a laser generator, the method comprising
reflecting light within a cavity of a laser resonator; and
passing at least a part of the light through a diffraction grating, wherein the diffraction grating is either periodic or quasi-periodic and either concentric or spiral and has a grating period larger than the wavelength of the laser radiation, in a manner such that the TM reflectance of the diffraction grating in a diffraction order corresponding to the laser wavelength is larger than the TE reflectivity of the diffraction grating in said diffraction order.

19. The method of claim 18, further comprising first forming the diffraction grating in a surface of a metallic substrate in a turning operation.

20. The method of claim 18, further comprising first forming the diffraction grating in a surface of a metallic substrate by etching the surface and subsequently coating the etched surface.
